(19) United States
(12) Patent Application Publication
(10) Pub. No.: US 2011/0170158 A1
(43) Pub. Date: Jul. 14, 2011

(54) OPTICAL SHUTTERING DEVICE AND METHOD OF MANUFACTURING THE SAME

(75) Inventors: Seog-Woo HONG, Yongin-si (KR); Che-Heung KIM, Yongin-si (KR); Joo-Ho LEE, Hwaseong-si (KR)

(73) Assignee: SAMSUNG ELECTRONICS CO., LTD., Suwon-si (KR)

(21) Appl. No.: 12/907,236

(22) Filed: Oct. 19, 2010

(30) Foreign Application Priority Data
Jan. 8, 2010 (KR) 10-2010-0001988

(51) Int. Cl. G02B 26/02; B05D 5/12

(52) U.S. Cl. 359/230; 427/58

(57) ABSTRACT

Provided is an optical shuttering device and a method of manufacturing the same. Device includes a roll-up blade that stays in a rolled-up state while no driving voltage is applied thereto and flattens to shutter a light-transmitting region when a predetermined driving voltage is applied to the roll-up blade. The roll-up blade may be provided as a single roll-up blade or as a plurality of roll-up blades such that the roll-up blade(s) shutters a a portion or the entirety of the light-transmitting region. The roll-up blade may be formed as a thin layer made of a single opaque, conductive material. As a single-layered structure, the roll-up blade may spontaneously roll up due to a stress gradient that is made in a thickness direction of the roll-up blade, and as a multi-layered structure, the roll-up blade may spontaneously roll up due to differences in mean stress of the multi layers.

### CROSS-REFERENCE TO RELATED APPLICATION

This application claims priority from Korean Patent Application No. 10-2010-0001988, filed on Jan. 8, 2010, the entire disclosure of which is incorporated herein by reference for all purposes.

### BACKGROUND

1. Field

The following description relates to digital imaging, and more particularly, to a micro mechanical global shutter and iris for digital imaging.

2. Description of the Related Art

Digital convergence is becoming increasingly widespread mostly due to the development of digital technologies. Digital convergence is most prominent in the field of media and communications. A representative digital convergence product is a so-called “camera phone” where an image pickup module such as a digital camera or a digital camcorder is combined with a mobile phone. Such an image pickup device has become commonly installed in various electronic devices including mobile phones, digital cameras, digital camcorders, laptop computers, Personal Digital Assistants (PDAs), robots, machine vision devices, automotive vision devices, and the like.

In response to recent consumer demands for high definition and high performance of image pickup devices, modules for offering various additional functions are being added to such image pickup devices. For example, a vari-focal fluidic lens may be added to an image pickup device to provide Auto Focus (AF), Zoom-in/out, optical image stabilization (OIS), Close-up, and so on. Recently, a mechanical optical shutter for performing mechanical shuttering as a substitute for electrical shuttering has been added to an image pickup device. The mechanical optical shutter is an optical shuttering device which controls the amount of light to be received by an image sensor by blocking all or some of light attempting to pass through to an imaging-forming optical system.

In order to meet the current demands for high definition and high performance of an image pickup device, a mechanical optical shutter has to have a very high response (shuttering) speed. Further, as electronic devices such an image pickup device are becoming increasingly small and slimline, a mechanical optical shutter needs to be manufactured to be small and thin. Moreover, a mechanical optical shutter has to maintain its physical and mechanical characteristics within the operating temperature range (for example, from −1 to 65° C.) of an image pickup device.

### SUMMARY

The following description relates to an optical shuttering device capable of maintaining its physical and mechanical characteristics within the operating temperature range of an image pickup device, and a method of manufacturing the optical shuttering device.

The following description also relates to an optical shuttering device including roll-up blades that have neither Radius of Curvature (RoC) changes nor differences in operating speed due to changes in temperature, and a method of manufacturing the optical shuttering device.

In one general aspect, there is provided an optical shuttering device including a substrate, a transparent electrode layer, an insulating layer and a roll-up blade. The substrate has a light-transmitting region. The transparent electrode layer is formed on the substrate, the insulting layer is formed on the transparent electrode layer and made of a transparent, insulative material. The roll-up blade is formed on the insulting layer and fixed at one end onto a part of the insulating layer outside the light-transmitting region to cover the light-transmitting region of the substrate, the roll-up blade formed as a thin layer made of a single opaque, conductive material. The roll-up blade spontaneously rolls up due to a stress gradient that is induced in a thickness direction of the thin layer, or the roll-up blade spontaneously rolls up due to differences in mean stress between the plurality of layers.

In another general aspect, there is provided an optical shuttering device including a substrate, a transparent electrode layer, an insulating layer and a plurality of roll-up blades. The substrate has a circular light-transmitting region. Transparent electrodes are formed on the substrate and formed with a light-transmitting, insulative material on the transparent electrode layer. The plurality of roll-up blades are formed on the insulating layer, each roll-up blade formed as a thin layer made of a single opaque, conductive material, wherein the plurality of roll-up blades are each fixed at one end thereof outside the light-transmitting region such that the fixed ends form a circle such that each roll-up blade shutters a fan-shaped segment of the light-transmitting region.

As such, in the optical shuttering device, the roll-up blades may be formed as a thin layer made of a single conductive material. Accordingly, unlike a conventional doubled-layered, roll-up blade composed of two layers that are made of heterogeneous materials having a large CTE difference therebetween, the roll-up blades may show constant physical and mechanical characteristics within the operating temperature range of an image pickup device (or the optical shuttering device). In particular, the optical shuttering deice including the roll-up blades may have neither RoC changes nor changes in operating speed due to changes in temperature, while ensuring high response speed.

In another general aspect, there is provide a method of manufacturing an optical shuttering device, including: forming a transparent electrode layer on a substrate having a light-transmitting region; forming a light-transmitting insulating layer on the transparent electrode layer; forming a sacrificial layer pattern to screen the light-transmitting region on the insulating layer; and forming a roll-up blade as a thin layer made of a single opaque, conductive material, on the sacrificial layer pattern and a part of the insulating layer on which no sacrificial layer pattern is formed; and removing the sacrificial layer pattern.

In this case, the roll-up blade is formed as a single thin layer in which stresses in a stress gradient varies from positive (+) to negative (−) with an increase in thickness of the thin layer, and the thin layer is deposited under a process condition which induces the stress to become greater in an upper portion of the thin layer than in an lower portion of the thin layer. The roll-up blade is formed to include a plurality of layers in which a mean stress of a upper layer is greater than a mean stress of a lower layer.

Other features and aspects will be apparent from the following detailed description, the drawings, and the claims.

### BRIEF DESCRIPTION OF THE DRAWINGS

FIG. 1A is a perspective view illustrating an example of an optical shuttering device when passing light.

FIG. 1B is a perspective view illustrating the optical shuttering device when shuttering light.

FIG. 2A is a cross-sectional view of the optical shuttering device taken along a line AA′ of FIG. 1A.

FIG. 2B is a cross-sectional view of the optical shuttering device taken along a line BB′ of FIG. 1B.

FIG. 3 is a graph showing changes in residual stress with respect to changes in layer thickness of roll-up blades.

FIG. 4 is a graph showing changes in radius of curvature (RoC) with respect to changes in temperature in a conventional roll-up blade made of SiN/Al.

FIG. 5 is a graph showing changes in RoC with respect to changes in temperature in a conventional roll-up blade formed of a single Mo layer.

FIG. 6A is a cross-sectional view of another example of the optical shuttering device taken along a line AA′ of FIG. 1A.

FIG. 6B is a cross-sectional view of another example of the optical shuttering device taken along a line BB′ of FIG. B.

FIGS. 7A through 7E are cross-sectional views for explaining an exemplary method of manufacturing an optical shuttering device.

FIGS. 8A through 8F are cross-sectional views for explaining another exemplary method of manufacturing an optical shuttering device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

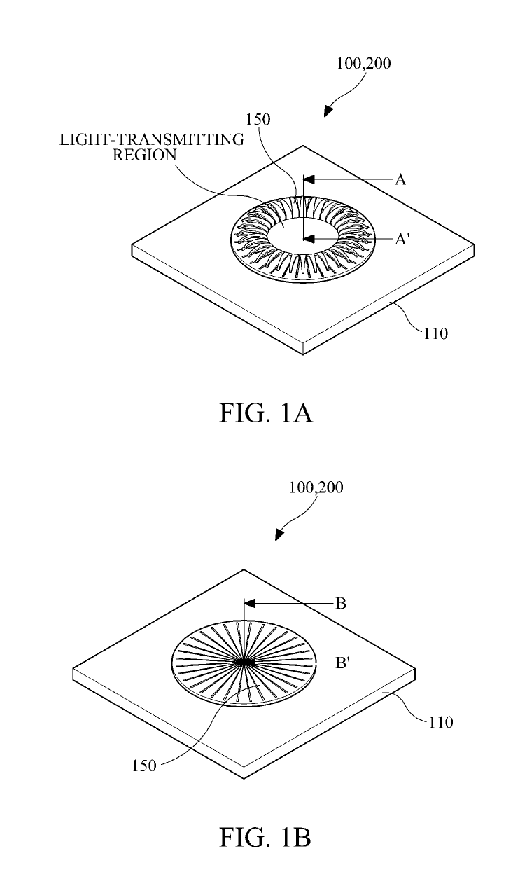

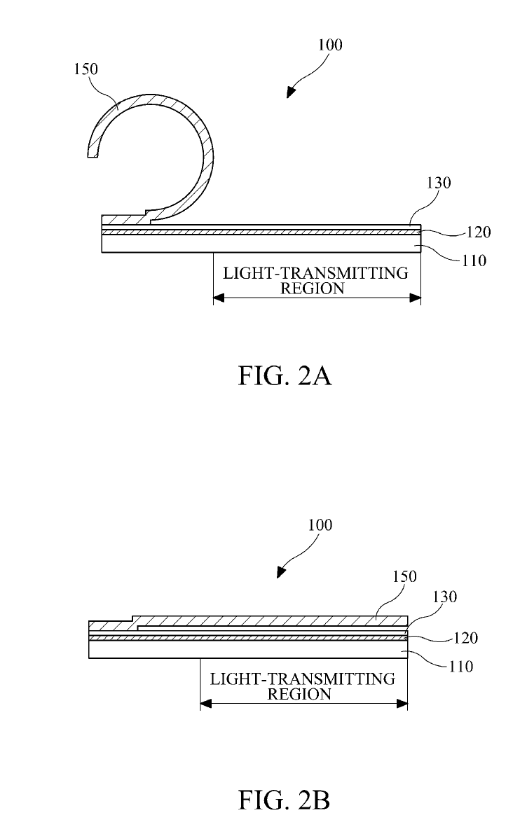

FIGS. 1A and 1B are perspective views illustrating a configuration of an optical shuttering device 100, wherein FIG. 1A shows a state where the optical shuttering device 100 passes light and FIG. 1B shows a state where the optical shuttering device 100 blocks light. FIG. 2A is a cross-sectional view of the optical shuttering device 100 taken along a line AA′ of FIG. 1A, and FIG. 2B is a cross-sectional view of the optical shuttering device 100 taken along a line BB′ of FIG. 1B. Referring to FIGS. 1A, 1B, 2A and 2B, the optical shuttering device 100 includes a substrate 110, a transparent electrode 120, an insulating layer 130 and roll-up blades 150. The optical shuttering device 100 may further include, while not illustrated in the drawings, a pair of electrode pads for connecting the transparent electrode 120 and roll-up blades 150 to a driving voltage source and a spacer for ensuring a space above the roll-up blades 150 for the movement of the roll-up blades 150.

The substrate 110 has a light-transmitting region. The light-transmitting region corresponds to a light path of an image-forming optical system which forms an image pickup device (for example, a digital camera) in which the optical shuttering device 100 is installed. Accordingly, when the roll-up blades 150 are rolled up (see FIG. 1A), the light-transmitting region is exposed to pass light, and when the roll-up blades 150 are flattened, the light-transmitting region is shuttered by the rollup blades 150 to block light. The light-transmitting region may be in the shape of a quadrangle, a circle, an oval or a polygon, and the light-transmitting region may be positioned in the center of the substrate 110.

The substrate 110 may be wholly made of a transparent material or only a part of the substrate 110 including the light-transmitting region may be made of a transparent material. For example, the substrate 110 may be a glass substrate, but may be formed of any other transparent material, for example, quartz, plastic, silica and the like.

On one surface of the substrate 110, a transparent electrode 120 is formed. The transparent electrode 120 may be made of a transparent conductive material, for example, Indium Tin Oxide (ITO), ZnO, SnO₂, Carbon Nano Tube (CNT), conductive polymer, etc. The transparent electrode 120 may be formed on the entire surface of the substrate 110 or at least over the entire light-transmitting region. Alternatively, the transparent electrode 120 may be formed with a predetermined pattern in the light-transmitting region. The transparent electrode 120 connects to an electrode from a driving voltage source, thus generating a driving power for driving the optical shuttering device 100, i.e., an attractive force for pulling the roll-up blades 150 toward the transparent electrode 120 to be flattened. The transparent electrode 120 may have a thickness of about 1000 to 3000 Å.

On the transparent electrode 120, the insulating layer 130 is formed. The insulating layer 130 may be made of a light-transmitting material since the insulating layer 130 is also disposed over the light-transmitting region. For example, the insulting layer 130 may be made of transparent SiO, SiN, AlN or the like. The insulating layer 130 prevents the roll-up blades 150 from contacting and electrically connecting to the transparent electrode 120, while protecting the transparent electrode 120. The insulating layer 130 may have a thickness of about 1000 to 2000 Å, for example, about 1500 Å.

Unlike a conventional technique, in the optical shuttering device 100, it is possible to make the thickness of the insulting layer 130 inserted between the transparent electrode 120 and roll-up blades 150 relatively low. In more detail, in a conventional optical shuttering device, roll-up blades may be disposed above an insulating layer which is formed over transparent electrode or the roll-up blades may be directly disposed on a transparent electrode since roll-up blades of the conventional shuttering device have a double-layered structure of an insulating layer (for example, silicon nitride) and a conductive layer (for example, aluminum). In the former case, since two insulating layers are positioned between the transparent electrode and the conductive layer of the roll-up blades, the entire structure is relatively thick. In the latter case, since the roll-up blades are rolled up by the difference in residual stress between the insulating layer and conductive layer, the insulating layer should be relatively thick (for example, about 3500 Å) to attain a desired Radius of Curvature (Roc) of the roll-up blades when the conductive layer has a thickness of about 5500 Å.

However, in the optical shuttering device 100 according to the current example, the insulating layer 130 may be formed at a thickness of about 1500 Å though the roll-up blades 150 are formed at a thickness of about 5500 Å. This is because the residual stress of the insulating layer 130 while operating the optical shuttering device 100 does not need to be considered. Accordingly, the optical shuttering device 100 may be designed to be thinner than the conventional optical shuttering device. Furthermore, since the gap between the transparent electrode 120 and roll-up blades 150 is less than that of the conventional optical shuttering device, the optical shuttering device 100 may be driven with a lower driving voltage. In addition, in the case of the conventional optical shuttering device with two insulating layers between the transparent electrode and roll-up blades, a dielectric-to-dielectric contact state is made. In this case, dielectric charging occurs when the optical shuttering device is driven for a long time, which causes sticking Such sticking is a factor which increases capacitance, resulting in delaying response speed as well as a reduction of life-time. Whereas, the optical shuttering device 100 suppresses occurrence of such a dielectric-to-dielectric contact state, thereby reducing dielectric charging to ensure a longer life-time and a high and more consistent response speed.

The roll-up blades 150 stay in a rolled-up state while no driving voltage is applied between the roll-up blades 150 and transparent electrode 120 (see FIG. 1A). In this state, the light-transmitting region of the substrate 110 is exposed to pass incident light. Meanwhile, when a driving voltage is applied between the roll-up blades 150 and transparent electrode 120, the roll-up blades 150 are flattened (see FIG. 1B). In this state, the light-transmitting region of the substrate 110 is shuttered by the roll-up blades 150 to block incident light.

For this, one end (referred to as a fixed end) of each of the roll-up blades 150 is fixed outside the light-transmitting region. For example, one end of each of the roll-up blades 150 may connect to a part of the insulating layer 130 outside the light-transmitting region. Alternatively, additional structures (for example, spacers) may be formed on the one end of each of the roll-up blades 150 so that the roll-up blades 150 are fixed on the insulating layer 130 or on the spacers. The remaining portions except the one end of each of the roll-up blades 150 are spaced apart from the insulating layer 130 (see FIG. 2B).

The roll-up blades 150 may be incorporated into one body or composed of a plurality of groups. In the former case, a single roll-up blade may be capable of shuttering the entire light-transmitting region, whereas in the latter case, a plurality of roll-up blades may be provided such that each roll-up blade shutters a fan-shaped segment of the light-transmitting region. For example, as illustrated in FIGS. 1A and 1B, the main portions of the plurality of roll-up blades 150 except their fixing ends extend in a radial direction from the center of the light-transmitting region such that each roll-up blade shutters a fan-shaped segment of the light-transmitting region. In this case, the roll-up blades 150 may each be fixed at one end thereof at the circumference of the light-transmitting region. The light-transmitting region may have a circular shape. When the light-transmitting region is in a circular shape, the roll-up blades 150 are configured allowing each roll-up blade to shutter a fan-shaped segment of the light-transmitting region.

The roll-up blades 150 may be formed as a single thin layer made of a single opaque, conductive material. For example, the roll-up blades 150 may be formed as a single layer made of an opaque metal material, such as Mo, Al, Ti, Ta, Cr, Au, Cu or the like. An electrode (for example, a positive pole (+)) of the roll-up blades 150 electrically connects to an electrode of the driving voltage source.

Unlike conventional roll-up blades formed of a double-layered structure of an insulating layer and a conductive layer having different tensile residual stresses (or mean stresses), the roll-up blades 150 are formed as a single layer made of a single conductive material. The roll-up blades 150 stay in a rolled-up state at a predetermined RoC while no driving voltage is applied thereto, like the conventional roll-up blades. In the current example, the roll-up blades 150 are configured to have a stress gradient in the thin layer to enable the roll-up blades 150 to spontaneously roll up. In more detail, the roll-up blades 150 has a stress gradient in the thickness direction of the thin layer, and the stress gradient is directed towards the upper surface of the thin layer. In other words, the roll-up blades 150 are thick enough to form a stress on the upper surface. Since the stress gradient is directed towards the upper surface of the thin layer, the roll-up blades 150 stay in a rolled-up state.

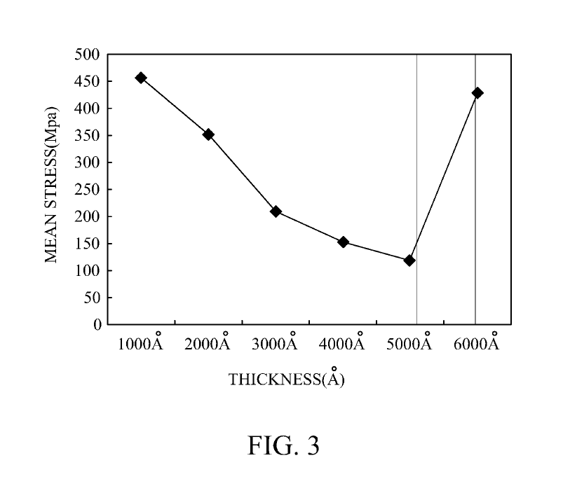

FIG. 3 is a graph showing changes in mean stress or residual stress with respect to changes in layer thickness of the roll-up blades 150. The graph shown in FIG. 3 corresponds to the case where a thin layer for the roll-up blades 150 is formed with Mo on a sacrificial layer made of parylene-based polymers. A conductive metal thin layer such as a Mo thin layer may be formed using a general metal deposition process, for example, Physical Vapor Deposition (PVD).

Referring to FIG. 3, with an increase in thickness of the Mo thin layer, the mean stress decreases (that is, a negative (−) stress portion of the stress gradient), and then increases (that is, a positive (+) stress portion of the stress gradient) when the thickness exceeds a predetermined limit (about 4500 Å in FIG. 3). It can be seen from FIG. 3 that the mean stress gradually decreases (that is, a small positive (+) stress portion of the stress gradient) and then sharply increases (that is, a large positive (+) stress portion of the stress gradient).

As such, the reason why the stress gradient of the roll-up blades 150 is directed towards the upper surface of the thin layer is because a coefficient of thermal expansion (CTE) of a material forming the sacrificial layer is different from a CTE of a material forming the roll-up blades 150. In more detail, the CTE of the material forming the lower sacrificial layer is much greater than the CTE of the material forming the roll-up blades 150. When a thin layer for the roll-up blades 150 is formed on the sacrificial layer, the material (for example, a parylene-based polymer) forming the sacrificial layer is significantly expanded under high-temperature conditions employed for depositing a thin layer. Consequently, a stress gradient is made in the thin layer of the roll-up blades 150 formed on the sacrificial layer, and the stress gradient is directed towards the upper surface of the thin layer.

Since the stress gradient in the roll-up blades 150 is directed towards the upper surface of the thin layer, the roll-up blades 150 spontaneously roll up at a predetermined RoC. The RoC of the roll-up blades 150 may be controlled by forming the sacrificial layer with a different kind of material, for example, by adjusting the difference in CTE between the sacrificial layer and the roll-up blades 150 or by changing the thickness of the sacrificial layer. For example, the RoC of the roll-up blades 150 may be reduced by forming the sacrificial layer with a material having a large CTE, that is, a material having a large CTE difference from the roll-up blades 150 and/or by increasing the thickness of the sacrificial layer. Meanwhile, the RoC of the roll-up blades 150 can be increased by forming the sacrificial layer with a material having a small CTE, that is, a material having a small CTE difference from the roll-up blades 150 and/or by decreasing the thickness of the sacrificial layer.

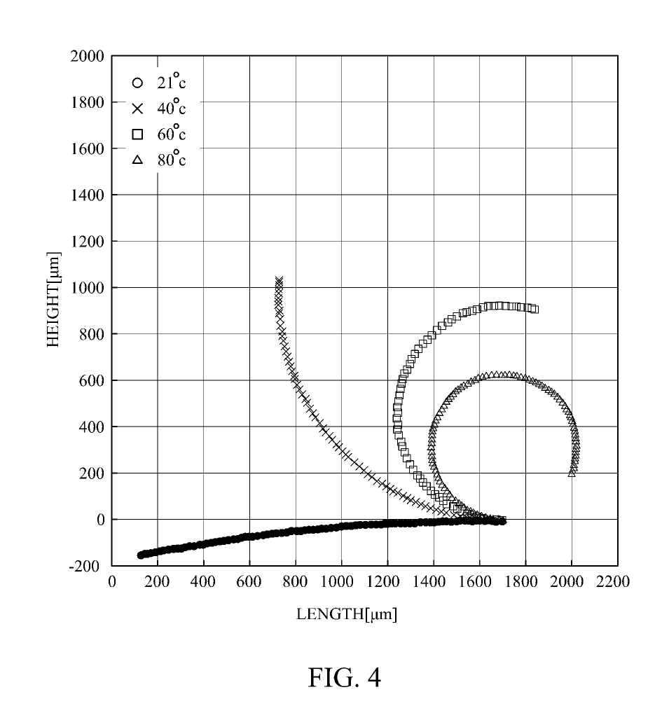

As such, the optical shuttering device 100 including the roll-up blades 150 made of a single material or an image pickup device including the optical shutter device 100 may attain consistent driving characteristics within its operating temperature range. The conventional roll-up blades 150 have a double-layered structure in which an insulating layer and a conductive layer made of heterogeneous materials are stacked. However, the CTE of a material (for example, SiN) forming the insulating layer is different from the CTE of a material (for example, Al) forming the conductive layer. Due to such a difference in CTE between the two materials, as seen in FIG. 4, the insulating layer (SiN) and conductive layer (Al) of the roll-up blades curve at different RoCs depending on changes in temperature.

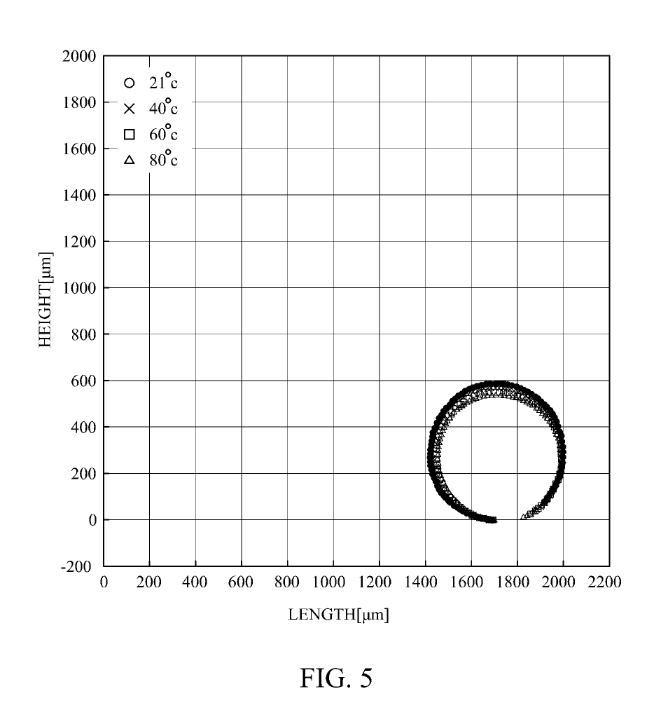

In more detail, the RoC is relatively small at a low temperature (for example, 21° C. or 40° C.) and relatively large at a high temperature (for example, 60° C. or 80° C.). Accordingly, at a high temperature, the roll-up blades may be flattened to shutter the light-transmitting region though no driving voltage is applied thereto. Also, at a low temperature, response speed of the roll-up blades may be lowered due to an overly small RoC, which may cause a problem upon initial driving. However, as seen in FIG. 5, in the roll-up blades 150 formed with a single conductive material, there are little changes in RoC in spite of changes in temperature. Therefore, temperature-related inconsistencies of the roll-up blades 150 shuttering the light-transmitting region or of lowering initial driving speed are minimized, and the optical shuttering device 100 including the roll-up blades 150 show approximately constant operating characteristics throughout an operational temperature range.

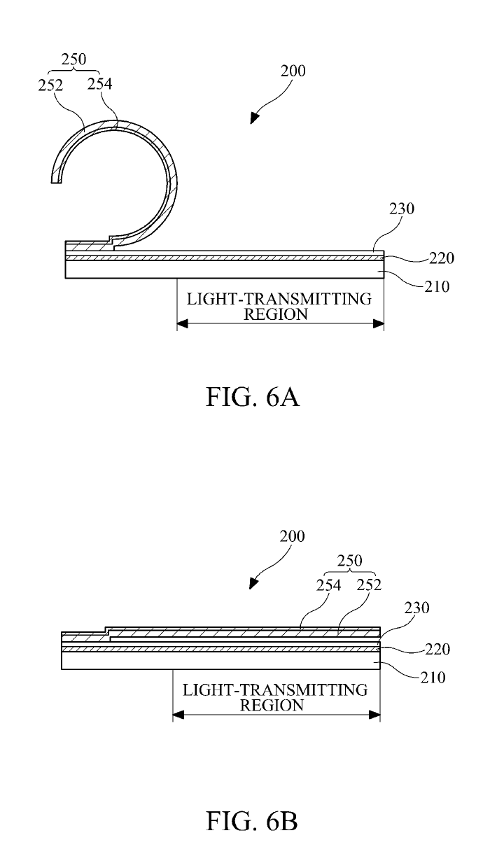

FIGS. 6A and 6B are cross-sectional views illustrating other examples of the optical shuttering device 200, wherein FIG. 6A shows the state where the optical shuttering device 200 passes light and FIG. 6B shows the state where the optical shuttering device 200 blocks light. The cross-sectional views shown in FIGS. 6A and 6B may respectively correspond to the perspective views shown in FIGS. 1A and 1B. In this case, FIG. 6A is a cross-sectional view of another example of the optical shuttering device 200 taken along a line AA′ of FIG. 1A, and FIG. 6B is a cross-sectional view of another example of the optical shuttering device 200 taken along a line BB′ of FIG. 1B. Referring to FIGS. 6A and 6B, the optical shuttering device 200 includes a substrate 210, a transparent electrode 200, an insulating layer 230 and a roll-up blade 250. The optical shuttering device 200 has the same structure as the optical shuttering device 100 described above, except for the structure of the roll-up blade 250, and accordingly, the following descriptions will be limited only to the roll-up blade 250.

Like in the above described case, the roll-up blade 250 stays in a rolled-up state while no driving voltage is applied. However, when a driving voltage is applied between the roll-up blade 250 and the transparent electrode 220, the roll-up blade 250 flattens. For this, one end (for example, a fixed end or a base end) of the roll-up blade is fixed outside the light-transmitting region. The main portion of the roll-up blade 250 except the end is spaced apart from the insulating layer 230 (see FIG. 6B). The roll-up blade 250 may be incorporated as one body or composed of a plurality of bodies. In the former case, a single roll-up blade may be provided capable of shuttering the entire light-transmitting region, whereas in the latter case, a plurality of roll-up blades are provided such that each roll-up blade shutters a fan-shaped segment of the light-transmitting region.

The roll-up blade 250 may be formed as a thin layer made of a single opaque material. Unlike the roll-up blades 150 (see FIGS. 2A and 2B) formed as a single thin layer, the roll-up blade 250 may be formed as a plurality of layers made of a single material. For example, the roll-up blade 250 may be formed as a double-layered or multi-layered structure using an opaque metal material, for example, Mo, Al, Ti, Ta, Cr, Au, Cu or the like.

In order to allow the roll-up blade 250 formed as a multi-layered structure made of a single material, to spontaneously roll up, in the current example, the roll-up blade 250 is configured to induce a difference in mean stress or residual stress between the upper and lower layers. In more detail, the roll-up blade 250 may be configured to spontaneously roll up by inducing a mean stress of the upper layer of the roll-up blade 250 greater than that of the lower layer of the roll-up blade 250. If the roll-up blade 250 is a three or more layered structure, the roll-up blade 250 may be configured to make a mean stress of the top layer become greatest.

In the current example, a method of controlling a mean stress or residual stress of the thin layer forming the roll-up blade 250 is not limited. For example, a residual stress of the thin layer may be adjusted by controlling process conditions (for example, air flow or changes in power) under which the thin layer is deposited. In this case, for example, the lower layer of the roll-up blade 250 may be deposited under a process condition where the residual stress is 100 MPa and the upper layer of the roll-up blade 250 may be deposited under a process condition where the residual stress is 350 MPa.

Alternatively, the roll-up blade 250 may be formed between two layers respectively made of different kinds of materials. The difference of the residual stresses between the two layers of the roll-up blade 250 may be induced by forming each of the two layers on the different kinds of materials under the same process conditions. For example, the lower layer of the roll-up blade 250 may be formed on a sacrificial layer made of a material (for example, a parylene-based polymer) having a large CTE difference from a material forming the roll-up blade 250, and the upper layer of the roll-up blade 250 may be formed on a layer (for example, a lower layer of the roll-up blade 250, deposited in advance) made of a material having a CTE that is the same as or similar to a CTE of the material forming the roll-up blade 250. In this case, if the roll-up blade 250 is made of Mo, the lower layer of the roll-up blade 250 may have a mean stress of about 100 MPa due to the large CTE of parylene-based polymers, and the upper layer of the roll-up blade 250 may have a mean stress of about 350 MPa that is an inherent residual stress of Mo since the upper layer of the roll-up blade 250 is formed on the layer having no significant difference in CTE from the upper layer of the roll-up blade 250.

In this way, by controlling process conditions when forming the upper and lower layers of the roll-up blade 250 or changing materials of layers onto which the roll-up blade 250 is formed, a mean stress difference occurs between the upper and lower layers of the roll-up blade 250 so that the roll-up blade 250 spontaneously rolls up due to the mean stress difference. Also, a RoC of the roll-up blade 250 may be controlled through control of the mean stress difference between the upper and lower layers of the roll-up blade 250. In addition, the mean stress difference between the upper and lower layers of the roll-up blade 250 may be controlled by using different thicknesses for the upper and lower layers of the roll-up blade 250. For example, when the roll-up blade 250 is designed to have a thickness of about 6000 Å, a thickness ratio of the lower and upper layers of the roll-up blade 250 may be set as 2000 Å:4000 Å, 4000 Å:2000 Å or 5000 Å:1000 Å. An increase in thickness of the lower layer causes a large mean stress difference, which reduces a RoC of the roll-up blade 250. When a roll-up blade is formed of a multi-layered structure made of a single conductive material, the roll-up blade may be designed to have a desired RoC by controlling process conditions, by changing materials of layers onto which the roll-up blade is formed or by appropriately adjusting a thickness ratio of the upper and lower layers of roll-up blade.

Like the example described above, the optical shuttering device 200 also includes a roll-up blade 250 made of a single material. Accordingly, the optical shuttering device 200 including the roll-up blade 250 may attain a constant RoC and driving characteristics within the operating temperature range of the optical shuttering device 200 (or an image pickup device including the optical shuttering device 200). As such, no problems occur such as the roll-up blade 250 shuttering a light-transmitting region at a high temperature or of lowering initial driving speed of the roll-up blade 250 at a low temperature.

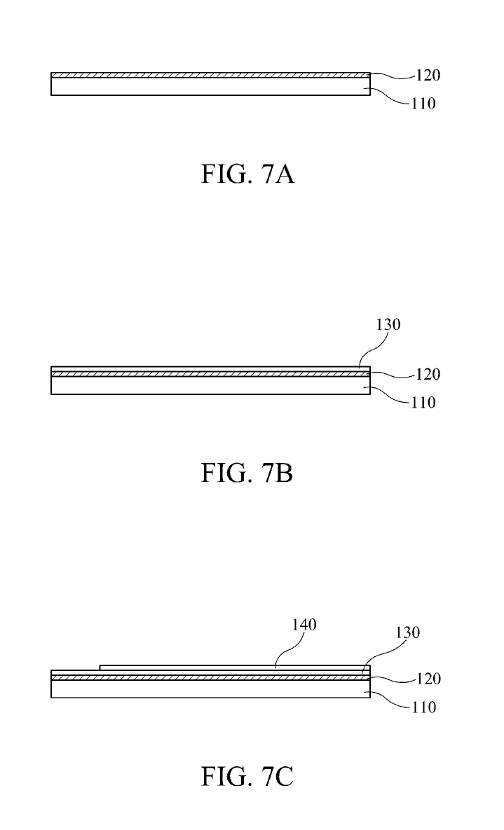

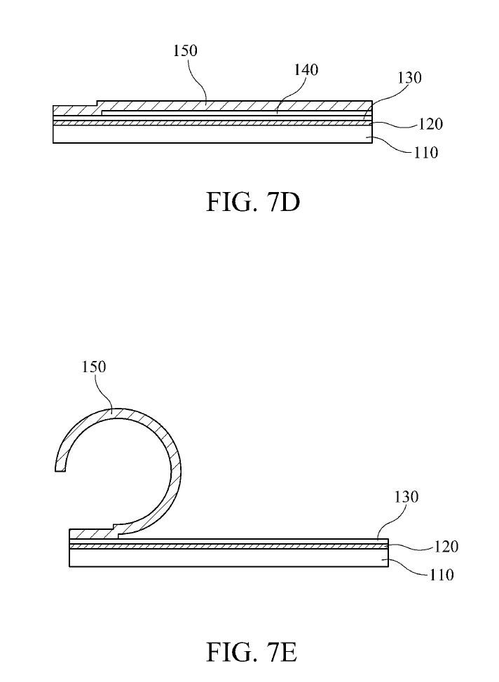

FIGS. 7A through 7E are cross-sectional views for explaining an exemplary method of manufacturing the optical shuttering device 100 described above with reference to FIGS. 2A and 2B.

Referring to FIG. 7A, a transparent electrode 120 is formed on a substrate 110 having a light-transmitting region. The substrate 110 may be a transparent glass substrate. The transparent electrode 120 may be made of a transparent conductive material such as ITO. A method of forming the transparent electrode 120 on the substrate 110 is not limited but may be a general semiconductor manufacturing process such as PVD. The transparent electrode 120 may be formed to have a thickness of about 1000 to 3000 Å, for example, about 2000 Å.

Referring then to FIG. 7B, an insulating layer 130 is formed on the transparent electrode 120. The insulating layer 130 may be made of a transparent material or an insulative material. For example, the insulating layer 130 may be made of SiO, SiN, SiON, AlN or the like. A method of forming the insulating layer 130 is not limited and may be a general semiconductor manufacturing process such as Chemical Vapor Deposition (CVD). The insulating layer 130 may be formed to have a thickness of about 1000 to 4000 Å, for example, about 1500 Å.

Referring to FIG. 7C, a sacrificial layer 140 is formed on the insulting layer 130. The sacrificial layer 140 may be made of a material having a large CTE difference from a roll-up blade 150 that is to be formed thereon. The sacrificial layer 140 may be made of a material having excellent etch selectivity against the roll-up blade 150 to be formed or made of an easily removable material. For example, the sacrificial layer 140 may be easily removed using an ashing process, and may be formed with parylene-based polymers having a relatively greater CTE than conductive metal materials, acrylate-based photoresistor or novolak-based photoresistor or the like.

The sacrificial layer 140 is formed to cover at least a light-transmitting region of the substrate 110. For example, as seen in FIG. 7C, the sacrificial layer 140 is formed only on a part of the insulating layer 130, and no sacrificial layer 140 is formed outside the light-transmitting layer, that is, on the remaining portion of the insulating layer 130 onto which the roll-up blade 150 is positioned (see FIG. 7D). The sacrificial layer 140 may be formed on a part of the insulating layer 130 by using a general semiconductor process method, for example, by forming a sacrificial layer 140 on the entire surface of the insulating layer 130 and then etching the sacrificial layer 140 or by depositing or applying a sacrificial layer 140 selectively on a predetermined region of the sacrificial layer 140.

Referring to FIG. 7D, the roll-up blade 150 is formed on the exposed insulating layer 130 and sacrificial layer 140. The roll-up blade 150 may be formed of a single layer made of an opaque metal material, for example, Mo, Al, Ti, Ta, Cr, Au, Cu or the like. When the roll-up blade 150 is formed as a plurality of groups, a single thin layer made of a metal material is formed and then patterned using a general semiconductor etching process, for example, dry etching. A method of forming a thin layer made of a metal material to form the roll-up blade 150 is not limited and may be a general semiconductor manufacturing process, for example, PVD.

As described above, by controlling the CTE and/or thickness of the sacrificial layer 140 below the roll-up blade 150, a residual stress or a stress gradient in the roll-up blade 150 may be controlled. Through control of the stress gradient in the roll-up blade 150, a RoC of the roll-up blade 150, which indicates a degree to which the roll-up blade 150 spontaneously rolls up after the sacrificial layer 140 is removed, may be controlled. Accordingly, the thickness of the roll-up blade 150 may be adaptively determined by considering the RoC to be finally attained. For example, when the sacrificial layer 140 is formed with parylene-based resin and a point of inflection of the residual stress of a Mo thin layer happens at a thickness of about 5000 Å, the roll-up blade 150 may be designed to have a thickness of about 5500 Å to 6000 Å.

Referring to FIG. 7E, the sacrificial layer 140 is selectively removed from the resultant structure illustrated in FIG. 7D. The sacrificial layer 140 may be removed using a general polymer removing process, for example, ashing. After the sacrificial layer 140 is removed, as illustrated in FIG. 7E, the roll-up blade 150 spontaneously rolls up and an optical shuttering device 100 having a desired RoC is complete.

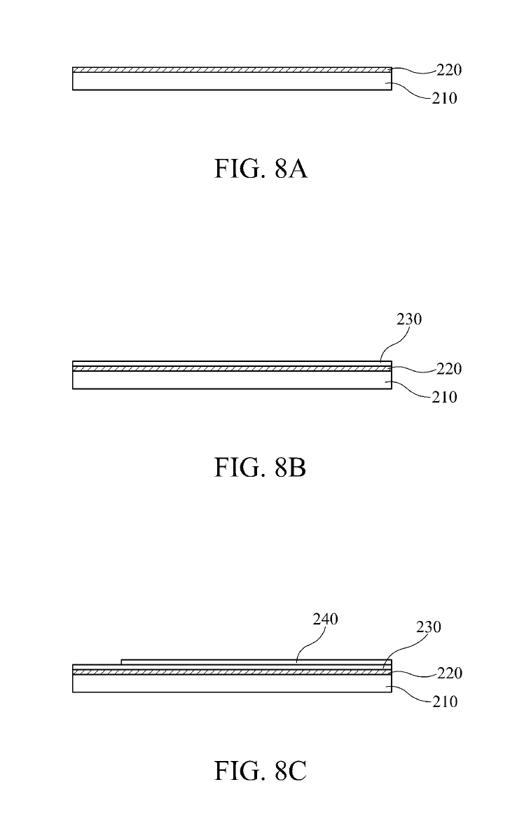

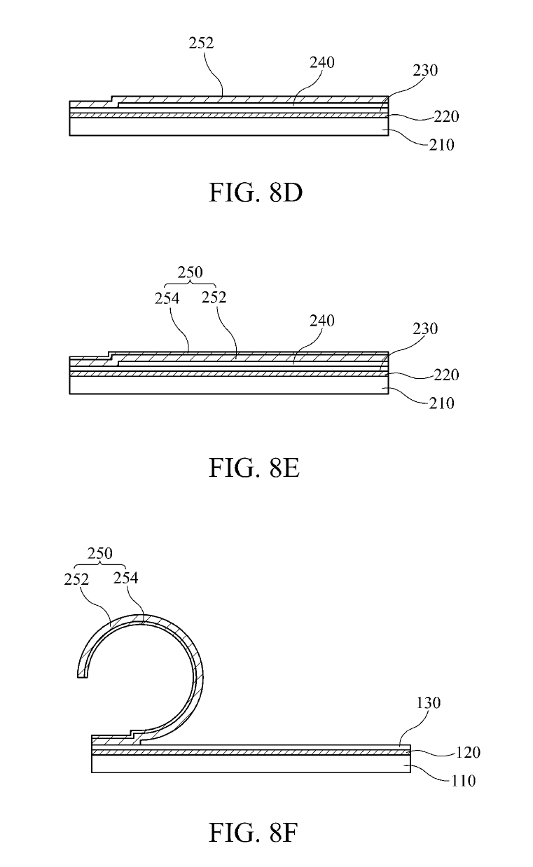

FIGS. 8A through 8F are cross-sectional views for explaining another exemplary method of manufacturing the optical shuttering device 200 described above with reference to FIGS. 6A and 6B. The current example is different from the above-described example in that a roll-up blade 250 has a multi-layered structure, for example, a double-layered structure. Accordingly, the current example will be described based on the difference in structure of the roll-up blade 250.

Referring to FIG. 8A, a transparent electrode 220 is formed on a substrate 210 having a light-transmitting region. The transparent electrode 220 may be formed at a thickness of about 1000 to 3000 Å, for example, about 2000 Å. Referring then to FIG. 8B, an insulating layer 230 is formed on the transparent electrode 220. The insulating layer 230 may be formed at a thickness of about 1000-4000 Å, for example, about 1500 Å. Referring successively to FIG. 8C, a sacrificial layer 240 is formed on the insulating layer 230. The sacrificial layer 240 may be made of a material having a large CTE difference from the roll-up blade 250 that is to be formed on the sacrificial layer 240, for example, made of a parylene-based resin. The thickness of the sacrificial layer 240 may be adaptively determined by considering a RoC of the roll-up blade 2540 to be formed.

Referring to FIG. 8D, a lower thin layer 252 of the roll-up blade 250 is formed on the exposed insulating layer 230 and sacrificial layer 240. The lower thin layer 252 may be formed with a conductive material, for example, Mo. The thin layer 252 may be formed at an appropriate thickness considering a residual stress (or a mean stress) of the roll-up blade 250. Referring then to FIG. 8E, a upper thin layer 254 of the roll-up blade 250 is formed on the lower thin layer 252 of the roll-up blade 250. The upper thin layer 254 may also be formed with the same material (for example, Mo) as the lower thin layer 252. The upper thin layer 254 may also be formed at an appropriate thickness considering the residual stress (or the mean stress) of the roll-up blade 250.

In this way, according to the current example, instead of forming a roll-up blade through one deposition, the roll-up blade 250 is formed by twice (or many times) performing deposition of the same material to stack a plurality of thin layers. This is aimed at causing the multi layers of the roll-up blade 250 to have different mean stresses to thus induce the roll-up blade 250 to roll up spontaneously. As described above, by forming the multi layers of the roll-up blade 250 under different process conditions, by forming the multi layers on layers made of different kinds of materials or by differentiating the thickness ratios of the multi layers, a residual stress or a mean stress of each layer of the roll-up blade 250 may be controlled. Accordingly, by controlling differences in mean stress of the multi layers of the roll-up blade 250, a RoC of the roll-up blade 250 may be controlled, indicating a degree at which the roll-up blade 250 spontaneously rolls up after the sacrificial layer 240 is removed.

Referring to FIG. 8F, the sacrificial layer 240 is selectively removed from the structure of FIG. 8E. The sacrificial layer 240 may be removed using a general polymer removing process, for example, ashing, however the method of removing the sacrificial layer 240 is not limited thereto. After the sacrificial layer 240 is removed, as seen in FIG. 8E, the roll-up blade 250 spontaneously rolls up due to the difference in mean stress between the lower layer 252 and upper layer 254, and as a result, an optical shuttering device 200 having a desired RoC is finally complete.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical shuttering device comprising:
a substrate comprising a light-transmitting region;
a transparent electrode layer disposed on the substrate;
a light-transmitting insulting layer disposed on the transparent electrode layer; and
a roll-up blade disposed on the light-transmitting insulting layer and fixed at one end onto a part of the light-transmitting insulating layer outside the light-transmitting region, the roll-up blade being a thin layer made of a single opaque, conductive material.

2. The optical shuttering device of claim 1, wherein the thin layer is a single layer and the roll-up blade rolls up due to a stress gradient in a thickness direction of the thin layer.

3. The optical shuttering device of claim 2, wherein in the roll-up blade, a stress of the stress gradient varies from positive (+) to negative (−) with an increase in thickness of the thin layer, and a stress at an upper portion of the thin layer is greater than a stress at a lower portion of the thin layer.

4. The optical shuttering device of claim 1, wherein the thin layer comprises a plurality of layers and the roll-up blade spontaneously rolls up due to differences in mean stress between the plurality of layers.

5. The optical shuttering device of claim 4, wherein a mean stress of an upper layer of the roll-up blade is greater than a mean stress of a lower layer of the roll-up blade.

6. The optical shuttering device of claim 1, comprising a plurality of roll-up blades which shutters fan-shaped segments of the light-transmitting region.

7. The optical shuttering device of claim 1, wherein the roll-up blade is made of a material or a combination of materials selected from a group consisting of Mo, Al and Ni.

8. An optical shuttering device comprising:
a substrate comprising a circular light-transmitting region;
a transparent electrode layer disposed on the substrate;
a light-transmitting insulting layer disposed on the transparent electrode layer; and
a plurality of roll-up blades disposed on the insulating layer, the plurality of roll-up blades being thin layers made of a single opaque, conductive material,
wherein one ends of the plurality of roll-up blades are fixed outside the light-transmitting region such that the fixed one ends form a circle and the plurality of the roll-up blades shutters fan-shaped segments of the light-transmitting region.

9. The optical shuttering device of claim 8, wherein the thin layers are single layers and the plurality of roll-up blades spontaneously rolls up due to a stress gradient in a thickness direction of the thin layers.

10. The optical shuttering device of claim 8, wherein the thin layers comprise a plurality of layers and the plurality of roll-up blades roll up due to differences in mean stress between the plurality of layers.

11. The optical shuttering device of claim 8, wherein the plurality of roll-up blades are made of a material or a combination of materials selected from a group consisting of Mo, Al and Ni.

12. A method of manufacturing an optical shuttering device, comprising:
forming a transparent electrode layer on a substrate having a light-transmitting region;
forming a light-transmitting insulating layer on the transparent electrode layer;
forming a sacrificial layer pattern to screen the light-transmitting region on the insulating layer; and
forming a roll-up blade as a thin layer made of a single opaque, conductive material, on the sacrificial layer pattern and a part of the insulating layer on which no sacrificial layer pattern is formed; and
removing the sacrificial layer pattern.

13. The method of claim 12, wherein the forming of the sacrificial layer pattern comprises forming the sacrificial layer pattern with one among parylene-based polymers, acrylate-based photoresistor and novolak-based photoresistor, and
the forming of the roll-up blade comprises forming the roll-up blade with a material or a combination of materials selected from a group consisting of Mo, Al, Ti, Ta, Au and Cu.

14. The method of claim 13, wherein the roll-up blade is formed as a single thin layer in which a stress of a stress gradient varies from positive (+) to negative (−) with an increase in thickness of the thin layer, and the thin layer is deposited under a process condition which induces a stress in an upper portion of the thin layer to be greater than a stress in an lower portion of the thin layer.

15. The method of claim 13, wherein the forming of the roll-up blade comprises forming the thin layer as a plurality of layers in which a mean stress of a upper layer is greater than a mean stress of a lower layer.

16. The method of claim 15, wherein the forming of the roll-up blade comprises:
forming a first blade layer on the sacrificial pattern and a part of the insulating layer on which no sacrificial layer pattern is formed; and
forming a second blade layer with the same material as that forming the first blade layer, on the first blade layer.
